(19) United States
(12) Patent Application Publication
(10) Pub. No.: US 2026/0029958 A1
(43) Pub. Date: Jan. 29, 2026

(54) ADAPTIVE PERFORMANCE TUNING FOR MEMORY SYSTEMS

(71) Applicant: Micron Technology, Inc., Boise, ID (US)

(72) Inventor: Royce K. Louis, Bangalore (IN)

(21) Appl. No.: 18/787,963

(22) Filed: Jul. 29, 2024

(51) Int. Cl. G06F 3/06

(52) U.S. Cl. CPC G06F 3/0659; G06F 3/0604; G06F 3/0679

(57) ABSTRACT

Methods, systems, and devices for adaptive performance tuning for memory systems are described. A memory system may apply a programming mode ratio. For example, the memory system may write data to single-level cell (SLC) word lines and multiple level cell word lines according to a ratio. The memory system may determine the ratio according to operating parameters, such as a command queue depth, size of commands in the command queue, host delays, an amount of free space, or the like. The memory system may determine the ratio based on whether the operating parameters satisfy thresholds. That is, the memory system may compare each operating parameter to one or more operating parameter thresholds.

### TECHNICAL FIELD

The following relates to one or more systems for memory, including adaptive performance tuning for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIGS. 1 and 2 show examples of systems that support adaptive performance tuning for memory systems in accordance with examples as disclosed herein.

FIG. 3 shows an example of a flow diagram that supports adaptive performance tuning for memory systems in accordance with examples as disclosed herein.

FIG. 4 shows a block diagram of a memory system that supports adaptive performance tuning for memory systems in accordance with examples as disclosed herein.

FIG. 5 shows a flowchart illustrating a method or methods that support adaptive performance tuning for memory systems in accordance with examples as disclosed herein.

### DETAILED DESCRIPTION

Memory systems, such as not-and (NAND) memory devices, may write data to different types of memory blocks. For example, memory systems may write data to single-level cell (SLC) blocks, multi-level cell (MLC) blocks, tri-level cell (TLC) blocks, quad-level cell (QLC) blocks, higher level cell blocks, or any combination thereof. In some cases, SLC blocks may be associated with a higher performance level than multiple level cell blocks, such as MLC blocks, TLC blocks, QLC blocks, and the like. For example, SLC blocks may have a faster programming time (e.g., write and read times) than the multiple level cell blocks and may have lower bit error rates than multiple level cell blocks. However, a quantity of SLC blocks may be limited in a memory system because the data is stored less densely than multiple level cell blocks. Accordingly, memory systems may support dynamic SLC schemes in which data may be initially written to SLC blocks before being written to multiple level cell blocks. For example, the memory system may write data to a quantity of blocks (e.g., temporarily) as SLC blocks to reduce the latency of performing the initial write operation. The memory system may later (e.g., in an idle time) transfer the data from the SLC blocks to multiple level cell blocks, such as via TLC folding. After receiving a write command, the memory system may write data (e.g., in an SLC mode) to the SLC blocks until an amount of available space is below a threshold. When the amount of available space (e.g., total available space in the memory system) drops below the threshold, the memory system may write data to the multiple level cell blocks (e.g., in a TLC or QLC mode). However, switching between writing to the SLC blocks and to multiple level cell blocks (e.g., switching from an SLC mode to a TLC or QLC mode) may cause sudden changes to performance (e.g., a sudden decrease in performance when switching from SLC blocks to TLC blocks) of the memory system. That is, a user may experience a sudden drop in performance as the memory system switches from higher performance SLC programming to lower performance TLC or QLC programming. Such a drop in performance may degrade a user experience.

As described herein, a memory system may avoid sudden performance drops associated with switching programming modes by applying adaptive performance tuning for memory systems. For example, the memory system may write data to SLC word lines and multiple level cell word lines according to a determined ratio. The memory system may determine the ratio according to operating parameters, such as a command queue depth, size of commands in the command queue, host delays, an amount of free space, or the like. In some examples, the memory system may determine the ratio based on whether the operating parameters satisfy thresholds. That is, the memory system may compare each operating parameter to one or more operating parameter thresholds. The memory system may determine the ratio by looking up an index in the mode register or via an algorithm that generates a weighted average of the operating parameters.

By applying adaptive performance tuning for memory systems, the memory system may support more gradual changes in performance (e.g., compared to cases in which the ratio is not applied). For example, rather than switching from an SLC programming mode to a TLC or QLC programming mode, the memory system may perform a combination of the SLC programming mode and the TLC or QLC programming mode.

In addition to applicability in memory systems as described herein, techniques for dynamically determining and applying a mode ratio may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by providing a smoother performance curve, which may improve user experience, among other benefits.

Features of the disclosure are illustrated and described in the context of systems, devices, and circuits. Features of the disclosure are further illustrated and described in the context of flowcharts.

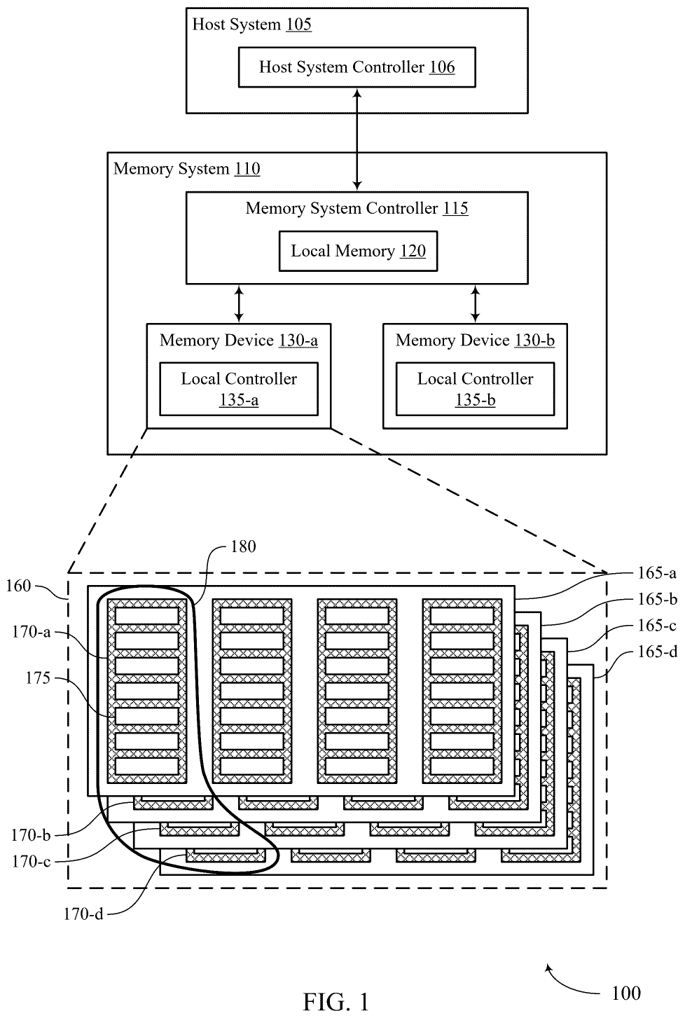

FIG. 1 shows an example of a system 100 that supports adaptive performance tuning for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

Some memory systems may switch between a dynamic SLC mode and a multiple level cell mode, such as a TLC mode. For example, at the beginning of usage of the memory system 110 (e.g., at the beginning of drive usage), a dynamic SLC cache threshold may be set. As an example, a dynamic SLC cache threshold of 20% of the capacity of the memory system 110 may support 60% of the capacity in SLC mode, while a remaining 40% of the capacity may be in a multiple level cell mode, such as TLC mode. In other words, the memory system 110 may convert a percentage of the capacity to be SLC blocks so long as the percentage is equal to or below the dynamic SLC cache threshold. The memory system 110 may perform initial write commands under an SLC mode (e.g., to SLC word lines). For example, the memory system 110 may initially support relatively high programming speeds as data is written in the SLC mode. However, after the memory system 110 writes data to the available dynamic SLC blocks, the memory system 110 may switch to the TLC mode. In such examples, a user may experience a sudden drop in performance, as the TLC mode performance may be slower (e.g., 5 times slower) than the SLC mode performance. Additionally, during an idle time, the memory system 110 may relocate the data written to dynamic SLC blocks to multiple level cell blocks, which may degrade a write performance.

As described herein, the memory system 110 may avoid sudden performance drops associated with switching programming modes by applying adaptive performance tuning for memory systems. For example, the memory system 110 may write data to SLC word lines and multiple level cell word lines according to a determined ratio. The memory system 110 may determine the ratio according to operating parameters, such as a command queue depth, size of commands in the command queue, host delays, an amount of free space, or the like. In some examples, the memory system 110 may determine the ratio based on whether the operating parameters satisfy thresholds. That is, the memory system 110 may compare each operating parameter to one or more operating parameter thresholds. The memory system 110 may determine the ratio in a mode register, such as based on looking up an index in the mode register, or via an algorithm that generates a weighted average of the operating parameters.

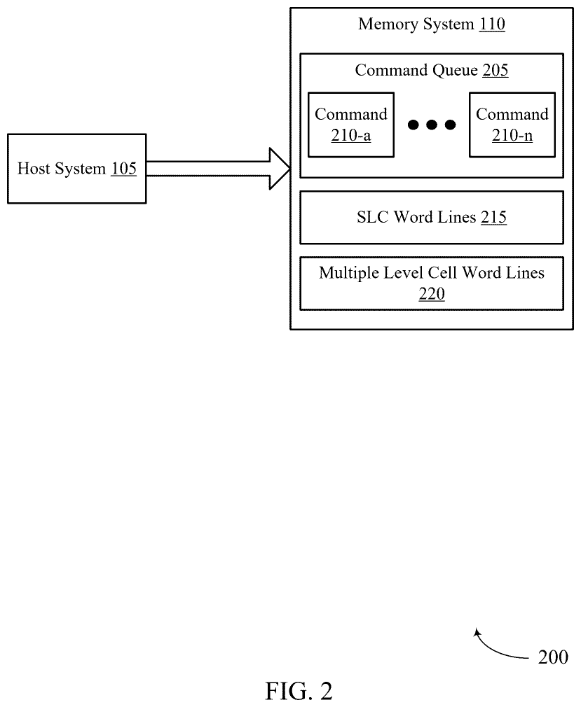

FIG. 2 shows an example of a system 200 that supports adaptive performance tuning for memory systems in accordance with examples as disclosed herein. The system 200 may be an example of a system 100 as described with reference to FIG. 1, or aspects thereof. For example, the system 200 may include the host system 105 and the memory system 110 as described with reference to FIG. 1. As used herein, a multiple level cell may refer to any memory cell configured to store two or more bits of information, such as an MLC, TLC, QLC, penta-level cells (PLCs), or beyond. Thus, a multiple level cell word line or a multiple level cell block includes MLCs, TLCs, QLCS, PLCs, or beyond.

The memory system 110 may write data to SLC word lines 215 and multiple level cell word lines 220 according to a ratio. For example, the memory system 110 may determine the ratio based on whether one or more operating parameters satisfy at least one threshold. The memory system 110 may write data from commands received from the host system 105 to the SLC word lines 215 and the multiple level cell word lines 220 in an alternating fashion. In other words, after writing data to an SLC word line of the SLC word lines 215, the memory system 110 may write data to a multiple level cell word line of the multiple level cell word lines 220. In order to switch between an SLC mode and a multiple level cell mode in between writing data to word lines, the memory system 110 may have a cursor on both an SLC block and a multiple level cell block. That is, the memory system 110 may write data according to the ratio in examples in which at least one SLC block and at least one multiple level cell block are available.

As used herein, ratio, mode ratio, or programming ratio may refer to a ratio between writing information into SLC word lines and writing information into multiple level cell word lines. The ratio may be an integer value, a percentage, or a decimal value. As an example, the ratio may be 2, where the memory system 110 may write information to 2 SLC word lines for every 1 multiple level cell word line. In another example, the ratio may be 50%, where the memory system 110 may write information to 1 SLC word line for every 2 multiple level cell word lines. Or, the ratio may be 0.25, where the memory system 110 may write information to 1 SLC word line for every 4 multiple level cell word lines. While examples of the ratio are described above, these examples of ratios may be modified. For example, a ratio of 2 may be implemented where the memory system 110 writes information to 2 multiple level cell word lines for every 1 single level cell word line. Subsequent description of the ratio is described using limited examples for clarity. However, the techniques related to the ratio may be modified to fit the different types of ratios that may be implemented. Multiple level cells may refer to a cell containing more than one bit of information. Multiple level cells may refer to MLCs (e.g., containing 2 bits), TLCs (e.g., containing 3 bits), QLCs (e.g., containing 4 bits), or the like. In some examples, multiple level cells may refer to combinations of two or more types of multiple level cells, such as TLCs and QLCs.

The ratio may be based on one or more operating parameters at the memory system 110. For example, the ratio may be based on a command queue depth, size of commands in the command queue, host delays, an amount of free space, or the like. The memory system 110 may compare respective operating parameters to one or more operating parameter thresholds. In some examples, each operating parameter may be associated with multiple operating parameter thresholds (e.g., defining ranges of operating parameter values). For example, the memory system 110 may categorize operating parameters into different ranges (e.g., buckets) corresponding to different ratios. Alternatively, the memory system 110 may calculate the ratio based on a weighted average of the operating parameters (e.g., values of the operating parameters, weighted according to preference, priority levels, importance, etc.).

The queue depth may refer to a quantity or amount of commands in the command queue 205. For example, the queue depth may refer to the quantity n of the command 210-a through the command 210-n in the command queue 205. In examples in which the queue depth is relatively small (e.g., below a threshold), the memory system 110 may write data to relatively more of the multiple level cell word lines 220 than SLC word lines 215. In other words, the memory system 110 may reduce the ratio as the queue depth decreases. Alternatively, in examples in which the queue depth is relatively large (e.g., above a threshold), the memory system 110 may write data to relatively more of the SLC word lines 215 than multiple level cell word lines 220. In other words, the memory system 110 may increase the ratio as the queue depth increases. That is, the memory system 110 may adaptively adjust the ratio to improve a throughput in examples in which the command queue 205 includes a large quantity of commands (e.g., above the threshold).

The size of commands may refer to an amount of information to be written for commands in the command queue 205. For example, the command 210-a through the command 210-n may each include an amount of data or information to be written by the memory system 110. Commands including relatively more data or information than other commands may require relatively more word lines when being written to word lines of the memory system 110. The size of commands in the command queue 205 may refer to a summation (e.g., total, combination, etc.) of the amount of data in each of the commands in the command queue 205 or sizes of individual commands (e.g., the command 210-a or the command 210-n). Because the size of the commands in the command queue 205 may refer to the summation of the amount of data in each of the commands, the size of the commands in the command queue 205 may satisfy one or more thresholds based on the command queue 205 including a large quantity of commands (e.g., regardless of a size of each command).

The memory system 110 may determine the ratio based on the size of the commands in the command queue 205. For example, in examples in which the size of the commands is relatively small (e.g., below a threshold), the memory system 110 may write data to relatively more of the multiple level cell word lines 220 than SLC word lines. In other words, the memory system 110 may reduce the ratio as the size of the commands decreases. Alternatively, in examples in which the size of the commands is relatively large (e.g., above a threshold), the memory system 110 may write data to relatively more of the SLC word lines 215 than multiple level cell word lines 220. In other words, the memory system 110 may increase the ratio as the command size increases. That is, the memory system 110 may adaptively adjust the ratio to improve a throughput in examples in which the command queue 205 includes relatively large sized commands (e.g., above the threshold).

The host delay may refer to an amount of time between received commands from the host system 105. That is, a host delay may refer to a time duration between a first command and a subsequent second command (e.g., where the first command and the second command are consecutive commands) sent by the host system 105 to the memory system 110. The memory system 110 may store or otherwise identify historical information associated with time durations between commands received from the host system 105. As an example, the memory system 110 may reference a histogram of host delays. The host delay may be associated with the queue depth. For example, in examples in which the host delay is relatively small (e.g., commands are received from the host system 105 at short intervals), the command queue 205 may build up. Alternatively, in examples in which the host delay is relatively large (e.g., commands are received from the host system 105 at long intervals), the command queue 205 may include few or no commands.

The memory system 110 may determine the ratio based on the host delay. For example, in examples in which the host delay is relatively large (e.g., above a threshold), the memory system 110 may write data to relatively more of the multiple level cell word lines 220 than SLC word lines. In other words, the memory system 110 may reduce the ratio as the host delay increases. That is, the memory system 110 may have enough time to complete a current command (e.g., while writing data to a higher quantity of multiple level cell word lines 220 than SLC word lines 215) before the host system 105 transmits a next command. In such examples, a user experience may not be degraded, as commands are executed at a same cadence as commands are sent by the host system 105. Alternatively, in examples in which the host delay is relatively small (e.g., below a threshold), the memory system 110 may write data to relatively more of the SLC word lines 215 than multiple level cell word lines 220. In other words, the memory system 110 may increase the ratio as the host delay decreases.

An amount of free space or available space may refer to an amount of blocks or word lines in the memory system 110 which are not programmed with data. For example, the amount of free space or available space may refer to SLC word lines, multiple level word lines, or both that the memory system 110 may write data to (e.g., without writing over other data). In examples in which the amount of free space is relatively small (e.g., below a threshold), the memory system 110 may write data to relatively more of the multiple level cell word lines 220 than SLC word lines. In other words, the memory system 110 may reduce the ratio as the amount of free space decreases. Alternatively, in examples in which the amount of free space is relatively large (e.g., above a threshold), the memory system 110 may write data to relatively more of the SLC word lines 215 than multiple level cell word lines 220. In other words, the memory system 110 may increase the ratio as the amount of free space increases. In some examples, the memory system 110 may not consider the amount of free space when determining the ratio. For example, the ratio may not be based on the amount of free space in examples in which the amount of free space is relatively high, such as above the threshold (e.g., the ratio may be based on the other operating parameters). Alternatively, in examples in which the amount of free space is relatively low, the ratio may be based on the amount of free space (e.g., regardless of the other operating parameters). As an example, the memory system 110 may write data to multiple level cell word lines 220 in examples in which there is little or no available space in the SLC word lines 215 (e.g., despite a command queue being long, including commands with large sizes, etc.).

The memory system 110 may determine the ratio in accordance with the different operating parameters. As an example, three scenarios are provided in Table 1 below, where the memory system 110 may use different ratios based on different operating parameters. In the following scenarios (shown in Table 1), the memory system 110 may have a TLC drive type, a capacity of 512 GB, an SLC performance of 5,000 MB/s, and a TLC performance of 1,000 MB/s.

TABLE 1

| Scenario | Ratio | Performance |
|---|---|---|
| Free Space: 512 GB | High | Approximately |
| Queue Depth: high | | 5,000 MB/s |
| Command Dize: large | | |
| Free Space: 200 GB | 1 (e.g., 1 SLC word line per | 3,000 MB/s |
| Queue Depth: high | 1 TLC WL) | |
| Command Size: large | | |
| Free Space: 400 GB | 0 (e.g., write TLC only) | 1,000 MB/s |
| Queue Depth: low | | |
| Host Delay: high | | |

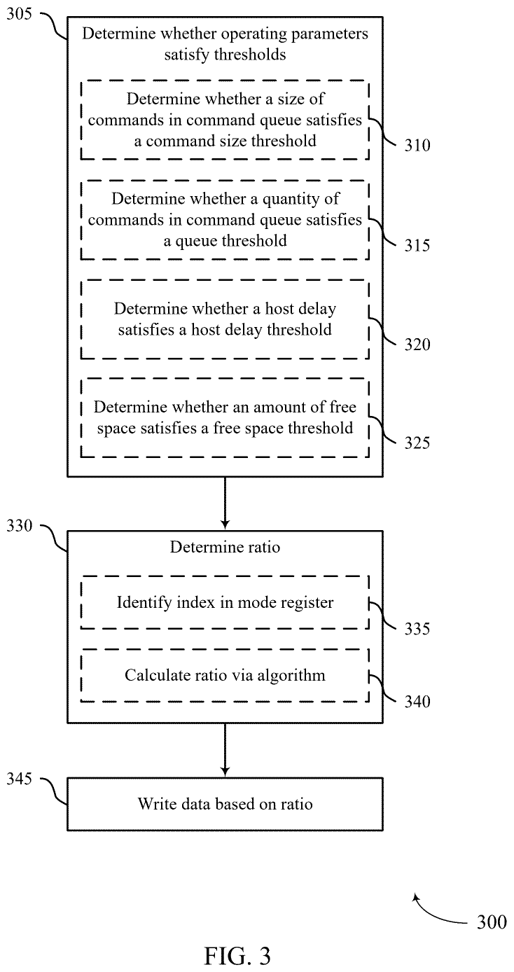

FIG. 3 shows an example of a flow diagram 300 that supports adaptive performance tuning for memory systems in accordance with examples as disclosed herein. In some examples, the flow diagram 300 may implement or be implemented by aspects of the system 100, the system 200, or both. For example, the flow diagram 300 may be implemented by a memory system, which may be an example of the memory system 110 as illustrated by and described with reference to FIGS. 1 and 2.

Alternative examples of the following may be implemented. Some operations are performed in a different order than described or are not performed at all. In some cases, operations may include additional features not mentioned below, or further operations may be added. Although the memory system is described as performing the operations of the flow diagram 300, some aspects of some operations may also be performed by one or more other systems or devices.

At 305, the memory system may determine whether operating parameters satisfy thresholds. For example, the memory system may determine whether one or more operating parameters of the memory system satisfy one or more thresholds. The one or more operating parameters may include a quantity of commands in a command queue, a size of one or more commands in the command queue, a host delay, an amount of free space in a memory drive of the memory system, or any combination thereof. Determining whether the one or more operating parameters of the memory system satisfy the one or more thresholds may include any combination of the operations at 310 through 325.

At 310, the memory system may determine whether a size of commands in a command queue satisfies a command size threshold. For example, the memory system may determine whether a size of one or more commands in a command queue satisfies a command size threshold, where the one or more operating parameters include the size of the one or more commands and the one or more thresholds include the command size threshold. The commands may be examples of the command 210-a or the command 210-n as described with reference to FIG. 2. Additionally, the command queue may be an example of the command queue 205 as described with reference to FIG. 2.

At 315, the memory system may determine whether a quantity of commands in a command queue satisfies a queue threshold. For example, the memory system may determine whether a quantity of commands in a command queue satisfies a queue threshold, where the one or more operating parameters include the quantity of commands and the one or more thresholds include the queue threshold.

At 320, the memory system may determine whether a host delay satisfies a host delay threshold. For example, the memory system may determine whether a host delay satisfies a host delay threshold, where the one or more operating parameters include the host delay and the one or more thresholds include the host delay threshold. The host delay may refer to an amount of time (e.g., an average amount of time) between commands received from a host system, such as the host system 105 as described with reference to FIGS. 1 and 2.

At 325, the memory system may determine whether an amount of free space satisfies a free space threshold. For example, the memory system may determine determining whether an amount of free space in a memory drive of the memory system satisfies a free space threshold, where the one or more operating parameters include the amount of free space and the one or more thresholds include the free space threshold. The amount of free space may refer to an amount of free space in the memory blocks or word lines of the memory system, such as an amount of free space in the SLC word lines 215, the multiple level cell word lines 220, or both as described with reference to FIG. 2.

At 330, the memory system may determine a ratio. For example, the memory system may determine a ratio between writing information into SLC word lines and writing information into multiple level cell word lines based on the one or more operating parameters satisfying at least one threshold. The ratio may include an integer value, a percentage, or a decimal value. Additionally, the multiple level cell word lines may include TLC word lines or QLC word lines.

At 335, the memory system may identify an index in a mode register. For example, the memory system may identify, based on the one or more operating parameters, an index in a mode register, where the index indicates the ratio corresponding to one or more ranges of operating parameters including the one or more operating parameters. In other words, the ratio may be found in a lookup table (e.g., in a bucket system). The one or more ranges of operating parameters may be defined according to the one or more thresholds of operations 305 through 325.

At 340, the memory system may calculate the ratio via an algorithm. For example, the memory system may determine the ratio in accordance with an algorithm, the algorithm including a weighted average of the one or more operating parameters. The memory system may include the operating parameters in the weighted average, or set coefficients for the weighted average, based on determining whether each of the parameters satisfies an associated threshold at 310 through 325. As an example, the memory system may exclude one or more parameters from the weighted average based on the amount of free space satisfying the threshold (e.g., satisfying a minimum threshold, having a small amount of free space, etc.).

At 345, the memory system may write data based on the ratio. For example, the memory system may write data to one or more SLC word lines of the memory system, one or more multiple level cell word lines of the memory system, or both based on the ratio. The data may be data included in write commands received from the host system. That is, the memory system may write the data based on receiving write commands received from the host system, where the data is written to a combination of SLC word lines and multiple level cell word lines based on operating parameters at the memory system (e.g., based on the ratio).

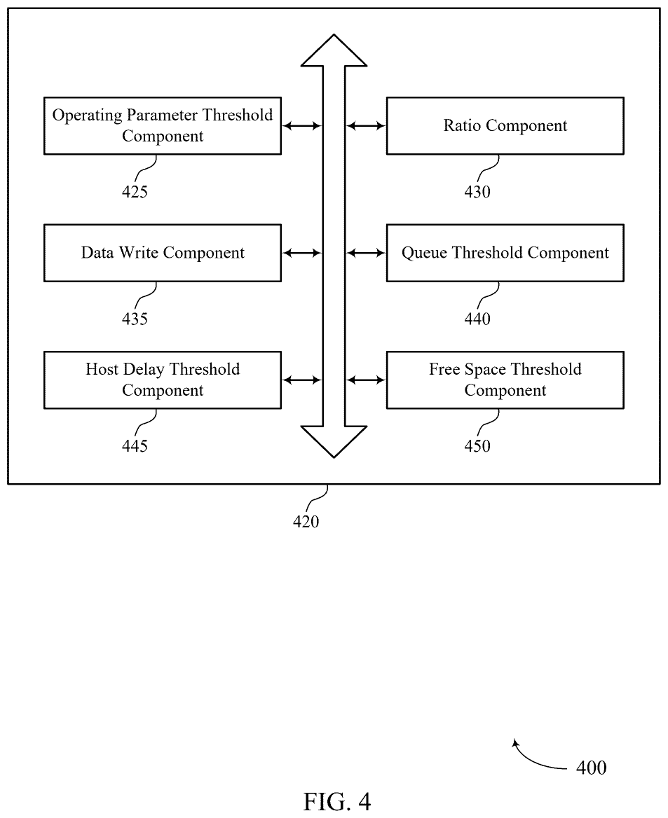

FIG. 4 shows a block diagram 400 of a memory system 420 that supports adaptive performance tuning for memory systems in accordance with examples as disclosed herein. The memory system 420 may be an example of aspects of a memory system as described with reference to FIGS. 1 through 3. The memory system 420, or various components thereof, may be an example of means for performing various aspects of adaptive performance tuning for memory systems as described herein. For example, the memory system 420 may include an operating parameter threshold component 425, a ratio component 430, a data write component 435, a queue threshold component 440, a host delay threshold component 445, a free space threshold component 450, or any combination thereof. Each of these components, or components of subcomponents thereof (e.g., one or more processors, one or more memories), may communicate, directly or indirectly, with one another (e.g., via one or more buses).

The operating parameter threshold component 425 may be configured as or otherwise support a means for determining whether one or more operating parameters of the memory system satisfy one or more thresholds. The ratio component 430 may be configured as or otherwise support a means for determining a ratio between writing information into SLC word lines and writing information into multiple level cell word lines based at least in part on the one or more operating parameters satisfying at least one threshold. The data write component 435 may be configured as or otherwise support a means for writing data to one or more SLC word lines of the memory system, one or more multiple level cell word lines of the memory system, or both based at least in part on the ratio.

In some examples, to support determining whether the one or more operating parameters satisfy the at least one threshold, the queue threshold component 440 may be configured as or otherwise support a means for determining whether a size of one or more commands in a command queue satisfies a command size threshold, where the one or more operating parameters include the size of the one or more commands and the one or more thresholds include the command size threshold.

In some examples, to support determining whether the one or more operating parameters satisfy the at least one threshold, the queue threshold component 440 may be configured as or otherwise support a means for determining whether a quantity of commands in a command queue satisfies a queue threshold, where the one or more operating parameters include the quantity of commands and the one or more thresholds include the queue threshold.

In some examples, to support determining whether the one or more operating parameters satisfy the at least one threshold, the host delay threshold component 445 may be configured as or otherwise support a means for determining whether a host delay satisfies a host delay threshold, where the one or more operating parameters include the host delay and the one or more thresholds include the host delay threshold.

In some examples, to support determining whether the one or more operating parameters satisfy the at least one threshold, the free space threshold component 450 may be configured as or otherwise support a means for determining whether an amount of free space in a memory drive of the memory system satisfies a free space threshold, where the one or more operating parameters include the amount of free space and the one or more thresholds include the free space threshold.

In some examples, the one or more operating parameters include a quantity of commands in a command queue, a size of one or more commands in the command queue, a host delay, an amount of free space in a memory drive of the memory system, or any combination thereof.

In some examples, to support determining the ratio, the ratio component 430 may be configured as or otherwise support a means for identifying, based at least in part on the one or more operating parameters, an index in a mode register, where the index indicates the ratio corresponding to one or more ranges of operating parameters including the one or more operating parameters.

In some examples, to support determining the ratio, the ratio component 430 may be configured as or otherwise support a means for determining the ratio in accordance with an algorithm, the algorithm including a weighted average of the one or more operating parameters.

In some examples, the ratio includes an integer value, a percentage, or a decimal value.

In some examples, the multiple level cell word lines include TLC word lines or QLC word lines.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

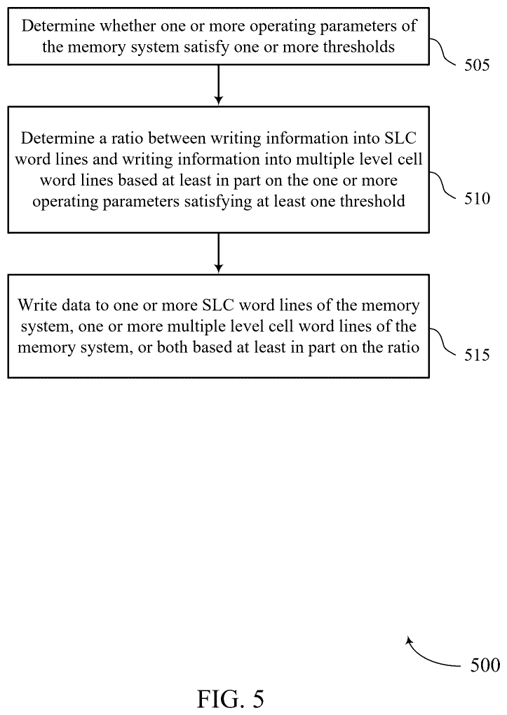

FIG. 5 shows a flowchart illustrating a method 500 that supports adaptive performance tuning for memory systems in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include determining whether one or more operating parameters of the memory system satisfy one or more thresholds. In some examples, aspects of the operations of 505 may be performed by an operating parameter threshold component 425 as described with reference to FIG. 4.

At 510, the method may include determining a ratio between writing information into SLC word lines and writing information into multiple level cell word lines based at least in part on the one or more operating parameters satisfying at least one threshold. In some examples, aspects of the operations of 510 may be performed by a ratio component 430 as described with reference to FIG. 4.

At 515, the method may include writing data to one or more SLC word lines of the memory system, one or more multiple level cell word lines of the memory system, or both based at least in part on the ratio. In some examples, aspects of the operations of 515 may be performed by a data write component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for determining whether one or more operating parameters of the memory system satisfy one or more thresholds; determining a ratio between writing information into SLC word lines and writing information into multiple level cell word lines based at least in part on the one or more operating parameters satisfying at least one threshold; and writing data to one or more SLC word lines of the memory system, one or more multiple level cell word lines of the memory system, or both based at least in part on the ratio.

Aspect 2: The method, apparatus, or non-transitory computer-readable medium of aspect 1, where determining whether the one or more operating parameters satisfy the at least one threshold includes operations, features, circuitry, logic, means, or instructions, or any combination thereof for determining whether a size of one or more commands in a command queue satisfies a command size threshold, where the one or more operating parameters include the size of the one or more commands and the one or more thresholds include the command size threshold.

Aspect 3: The method, apparatus, or non-transitory computer-readable medium of any of aspects 1 through 2, where determining whether the one or more operating parameters satisfy the at least one threshold includes operations, features, circuitry, logic, means, or instructions, or any combination thereof for determining whether a quantity of commands in a command queue satisfies a queue threshold, where the one or more operating parameters include the quantity of commands and the one or more thresholds include the queue threshold.

Aspect 4: The method, apparatus, or non-transitory computer-readable medium of any of aspects 1 through 3, where determining whether the one or more operating parameters satisfy the at least one threshold includes operations, features, circuitry, logic, means, or instructions, or any combination thereof for determining whether a host delay satisfies a host delay threshold, where the one or more operating parameters include the host delay and the one or more thresholds include the host delay threshold.

Aspect 5: The method, apparatus, or non-transitory computer-readable medium of any of aspects 1 through 4, where determining whether the one or more operating parameters satisfy the at least one threshold includes operations, features, circuitry, logic, means, or instructions, or any combination thereof for determining whether an amount of free space in a memory drive of the memory system satisfies a free space threshold, where the one or more operating parameters include the amount of free space and the one or more thresholds include the free space threshold.

Aspect 6: The method, apparatus, or non-transitory computer-readable medium of any of aspects 1 through 5, where the one or more operating parameters include a quantity of commands in a command queue, a size of one or more commands in the command queue, a host delay, an amount of free space in a memory drive of the memory system, or any combination thereof.

Aspect 7: The method, apparatus, or non-transitory computer-readable medium of any of aspects 1 through 6, where determining the ratio includes operations, features, circuitry, logic, means, or instructions, or any combination thereof for identifying, based at least in part on the one or more operating parameters, an index in a mode register, where the index indicates the ratio corresponding to one or more ranges of operating parameters including the one or more operating parameters.

Aspect 8: The method, apparatus, or non-transitory computer-readable medium of any of aspects 1 through 7, where determining the ratio includes operations, features, circuitry, logic, means, or instructions, or any combination thereof for determining the ratio in accordance with an algorithm, the algorithm including a weighted average of the one or more operating parameters.

Aspect 9: The method, apparatus, or non-transitory computer-readable medium of any of aspects 1 through 8, where the ratio includes an integer value, a percentage, or a decimal value.

Aspect 10: The method, apparatus, or non-transitory computer-readable medium of any of aspects 1 through 9, where the multiple level cell word lines include TLC or QLC word lines.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method by a memory system, comprising:
determining whether one or more operating parameters of the memory system satisfy one or more thresholds;
determining a ratio between writing information into single-level cell word lines and writing information into multiple level cell word lines based at least in part on the one or more operating parameters satisfying at least one threshold; and
writing data to one or more single-level cell word lines of the memory system, one or more multiple level cell word lines of the memory system, or both based at least in part on the ratio.

2. The method of claim 1, wherein determining whether the one or more operating parameters satisfy the at least one threshold comprises:
determining whether a size of one or more commands in a command queue satisfies a command size threshold, wherein the one or more operating parameters comprise the size of the one or more commands and the one or more thresholds comprise the command size threshold.

3. The method of claim 1, wherein determining whether the one or more operating parameters satisfy the at least one threshold comprises:
determining whether a quantity of commands in a command queue satisfies a queue threshold, wherein the one or more operating parameters comprise the quantity of commands and the one or more thresholds comprise the queue threshold.

4. The method of claim 1, wherein determining whether the one or more operating parameters satisfy the at least one threshold comprises:
determining whether a host delay satisfies a host delay threshold, wherein the one or more operating parameters comprise the host delay and the one or more thresholds comprise the host delay threshold.

5. The method of claim 1, wherein determining whether the one or more operating parameters satisfy the at least one threshold comprises:
determining whether an amount of free space in a memory drive of the memory system satisfies a free space threshold, wherein the one or more operating parameters comprise the amount of free space and the one or more thresholds comprise the free space threshold.

6. The method of claim 1, wherein the one or more operating parameters comprise a quantity of commands in a command queue, a size of one or more commands in the command queue, a host delay, an amount of free space in a memory drive of the memory system, or any combination thereof.

7. The method of claim 1, wherein determining the ratio comprises:
identifying, based at least in part on the one or more operating parameters, an index in a mode register, wherein the index indicates the ratio corresponding to one or more ranges of operating parameters comprising the one or more operating parameters.

8. The method of claim 1, wherein determining the ratio comprises:
determining the ratio in accordance with an algorithm, the algorithm comprising a weighted average of the one or more operating parameters.

9. The method of claim 1, wherein the ratio comprises an integer value, a percentage, or a decimal value.

10. The method of claim 1, wherein the multiple level cell word lines comprise tri-level cell (TLC) word lines or quad-level cell (QLC) word lines.

11. A non-transitory computer-readable medium storing code, the code comprising instructions executable by one or more processors to:
determine whether one or more operating parameters of a memory system satisfy one or more thresholds;
determine a ratio between writing information into single-level cell word lines and writing information into multiple level cell word lines based at least in part on the one or more operating parameters satisfying at least one threshold; and
write data to one or more single-level cell word lines of the memory system, one or more multiple level cell word lines of the memory system, or both based at least in part on the ratio.

12. The non-transitory computer-readable medium of claim 11, wherein the instructions to determine whether the one or more operating parameters satisfy the at least one threshold are executable by the one or more processors to:
determine whether a size of one or more commands in a command queue satisfies a command size threshold, wherein the one or more operating parameters comprise the size of the one or more commands and the one or more thresholds comprise the command size threshold.

13. The non-transitory computer-readable medium of claim 11, wherein the instructions to determine whether the one or more operating parameters satisfy the at least one threshold are executable by the one or more processors to:
determine whether a quantity of commands in a command queue satisfies a queue threshold, wherein the one or more operating parameters comprise the quantity of commands and the one or more thresholds comprise the queue threshold.

14. The non-transitory computer-readable medium of claim 11, wherein the instructions to determine whether the one or more operating parameters satisfy the at least one threshold are executable by the one or more processors to:
determine whether a host delay satisfies a host delay threshold, wherein the one or more operating parameters comprise the host delay and the one or more thresholds comprise the host delay threshold.

15. The non-transitory computer-readable medium of claim 11, wherein the instructions to determine whether the one or more operating parameters satisfy the at least one threshold are executable by the one or more processors to:
determine whether an amount of free space in a memory drive of the memory system satisfies a free space threshold, wherein the one or more operating parameters comprise the amount of free space and the one or more thresholds comprise the free space threshold.

16. The non-transitory computer-readable medium of claim 11, wherein the one or more operating parameters comprise a quantity of commands in a command queue, a size of one or more commands in the command queue, a host delay, an amount of free space in a memory drive of the memory system, or any combination thereof.

17. The non-transitory computer-readable medium of claim 11, wherein the instructions to determine the ratio are executable by the one or more processors to:
identifying, based at least in part on the one or more operating parameters, an index in a mode register, wherein the index indicates the ratio corresponding to one or more ranges of operating parameters comprising the one or more operating parameters.

18. The non-transitory computer-readable medium of claim 11, wherein the instructions to determine the ratio are executable by the one or more processors to:
determine the ratio in accordance with an algorithm, the algorithm comprising a weighted average of the one or more operating parameters.

19. The non-transitory computer-readable medium of claim 11, wherein the ratio comprises an integer value, a percentage, or a decimal value.

20. The non-transitory computer-readable medium of claim 11, wherein:
the multiple level cell word lines comprise tri-level cell (TLC) word lines or quad-level cell (QLC) word lines.

21. A memory system, comprising:
one or more memory devices; and
processing circuitry coupled with the one or more memory devices and configured to cause the memory system to:
determine whether one or more operating parameters of the memory system satisfy one or more thresholds;
determine a ratio between writing information into single-level cell word lines and writing information into multiple level cell word lines based at least in part on the one or more operating parameters satisfying at least one threshold; and
write data to one or more single-level cell word lines of the memory system, one or more multiple level cell word lines of the memory system, or both based at least in part on the ratio.

22. The memory system of claim 21, wherein determining whether the one or more operating parameters satisfy the at least one threshold comprises the processing circuitry configured to cause the memory system to:
determine whether a size of one or more commands in a command queue satisfies a command size threshold, wherein the one or more operating parameters comprise the size of the one or more commands and the one or more thresholds comprise the command size threshold.
